(19) United States
(12) Patent Application Publication
(10) Pub. No.: US 2004/0226938 A1
(43) Pub. Date: Nov. 18, 2004

(54) Block heater

(75) Inventors: Tadao Nakajima, Tokyo (JP); Kazuhito Shimomura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NIPPON THERMOSTAT CO., LTD., Kiyose-City (JP)

(21) Appl. No.: 10/785,020

(22) Filed: Feb. 25, 2004

(30) Foreign Application Priority Data
Feb. 26, 2003 (JP) 2003-048397

(51) Int. Cl. H05B 3/10

(52) U.S. Cl. 219/548; 219/534

(57) ABSTRACT

Provided is a block heater structured so as to be capable of maintaining the thermal transmission and thermal effect, as well as the mechanical strength, in a prescribed state in the respective components upon assembling the sheathed heater, cylindrical body, cap, and so on of the engine cooling water antifreeze block heater. This block heater has a sheathed heater 2 having a heating element 18 embedded in heat-resistant insulation powder 22 inside a sheath 11; a cylindrical body 3 for retaining the back-end portion of the sheathed heater and mounted onto a heater mounting portion of an automotive engine block; and a cap 4 attached to the opposite end of the sheathed heater of this cylindrical body, and structured so as to retain the heater connection end of a cable 5 having a power supply outlet at one end thereof. A gap 30 is provided between the end on the cap side of the cylindrical body and the end on the body side of the cap. A gap 33 is also provided between the end on the sheathed heater side in the sheathed heater retaining portion formed with the cylindrical body and the heating element constituted by heating wire inside the sheathed heater.

### BACKGROUND OF THE INVENTION

1. Field of the Invention

The present invention pertains to a block heater comprising as its heating element a sheathed heater mounted onto an area, an engine block for instance, that is in contact with the cooling water inside an automotive engine water jacket, and used for keeping the engine cooling water warm in cold climates and preventing the freezing thereof.

2. Description of the Related Art

Automobiles used in arctic areas such as Canada, Russia or various Northern Europe countries are subject to an environment of roughly minus several tens of C°. Under such conditions, the engine cooling water will freeze.

Consequently, a so-called cold climate type automobile for use in arctic areas described above is equipped with a heater in the engine block as a means for preventing the freezing of the cooling water. And, in small hours where the automobile is not being used, the power outlet on the tip of the cable pulled out from the heater provided inside and so as to face the engine block is connected to a household power source, and the sheathed heater is heated thereby so as to prevent the freezing of the cooling water in the engine water jacket and to improve the start ability of the engine. When using the automobile, the automobile may be used upon pulling out the outlet, bundling the cable together and storing it inside the engine room.

With the foregoing engine cooling water antifreeze heater, various types of structures are conventionally known as the sheathed heater to become the heating element. In other words, this type of sheathed heater is formed by taking a heating element, which is structured by penetrating two rod-shaped conductors through a rod-shaped core made from ceramic or the like as well as winding heating wire around the periphery of such core and connecting the respective ends thereof to the rod-shaped conductors, and disposing it inside a single or double cylindrical sheath, and embedding this within insulation powder (see Japanese Utility Model Laid-Open Publication No. S58-41996, Japanese Patent Laid-Open Publication No. S60-77395 and Japanese Patent No. 2768436).

With the sheathed heaters disclosed in the foregoing cited references, when the heater is mounted onto an area in contact with the cooling water inside the automotive engine water jacket for preventing the freezing of the engine cooling water, the following problems will arise.

In other words, with this type of sheathed heater, the back-end side there of is retained with a cylindrical body. And, an end of the cable to be connected to the rod-shaped conductor of the heater is attached to the other end of this cylindrical body via a cap, and a power source outlet connectable to a household power source is further mounted onto the other end of this cable so as to constitute an engine cooling water antifreeze block heater.

This type of block heater is mounted onto the engine block with a cylindrical body in a state where the sheathed heater, which is to become the heating element, faces an area in contact with the cooling water inside the engine water jacket from a mounting portion provided to a prescribed location in contact with the cooling water inside the engine water jacket.

In this kind of block heater mounted as described above, for instance, when the cooling water inside the engine water jacket decreases more than a certain level and nearly runs out, so-called low-water condition is established. In other words, heat transmission from the sheathed heater as the heating element will make the cylindrical body and cap a high temperature, and the cap may melt and become damaged due to the influence of heat. As a result, this will lead to a problem such as the function as an engine cooling water antifreeze heater being lost.

Further, when the heating portion and cylindrical body of the sheathed heater are in close proximity, heat will escape from the heater to the body, and there is a problem in that the heat generated with the heating portion of the heater cannot be efficiently transmitted to the cooling water side inside the engine water jacket. Thus, in order to attain a desired engine cooling water antifreeze effect, it is necessary to enlarge the heater capacity in advance, and the power consumption will increase as a result thereof. In addition, with this kind of constitution, the copper pipe to be the sheath may melt at the outside of the heater.

Moreover, with the constitution described above, a problem will also arise with the fixing means at the retaining portion for retaining the sheathed heater with the cylindrical body. In other words, although it is most standard to employ a constitution of fixing the sheath at the outside of the heater by fitting and caulking it into the cylindrical body, with this kind of constitution, the retaining portion sometimes becomes disengaged due to engine vibration, or thermal expansion or thermal contraction caused by the heat generation of the heater. This problem occurs even if the foregoing retaining portion is fixed into place with soldering, and some type of measure for securing the reliable fixed state of the heater to the body with the retaining portion is being sought.

### SUMMARY OF THE INVENTION

The present invention was devised in view of the foregoing circumstances, and an object thereof is to provide a block heater to be mounted onto an area (e.g., engine block) in contact with the cooling water inside the engine water jacket for preventing the freezing of an engine cooling water, wherein this block heater is structured so as to be capable of maintaining the thermal transmission and thermal effect, as well as the mechanical strength, in a prescribed state in the respective components upon assembling the sheathed heater, cylindrical body, cap, and so on.

In order to achieve the foregoing object, the block heater according to the present invention (invention according to claim 1) comprises: a sheathed heater having a heating element embedded in heat-resistant insulation powder inside a heat-resistant metal sheath; a cylindrical body for retaining the back-end portion of the sheathed heater and mounted onto a heater mounting portion at an area in contact with the cooling water inside an automotive engine water jacket; and a cap attached to the opposite end of the sheathed heater of the cylindrical body, and structured so as to retain an end of a cable connected with a sheathed heater, the cable having a power supply outlet at the other end thereof, and the connected end being constructed connectably to the sheathed heater; wherein a gap is defined between the end on the cap side of the cylindrical body and the end on the body side of the cap.

Here, the gap may be formed between the end portions of the cylindrical body and cap so as to define clearance of a prescribed measurement in the axial direction.

As a result of adopting the foregoing constitution, since the cylindrical body for retaining the back-end portion of the sheathed heater to become the heating element and the cap for retaining the cable connection end will be connected via a prescribed gap, heat transmission from the body side to the cap can be held to a minimum, and the cap will therefore not melt.

Further, the block heater according to the present invention (invention according to claim 3) comprises a sheathed heater having a heating element embedded in heat-resistant insulation powder inside a heat-resistant metal sheath; a cylindrical body for retaining the back-end portion of the sheathed heater and mounted onto a heater mounting portion at an area in contact with the cooling water inside an automotive engine water jacket; and a cap attached to the opposite end of the sheathed heater of the cylindrical body, and structured so as to retain the connection end for connection with a sheathed heater of a cable having a power supply outlet at one end thereof, where with the connection end being connectable to the sheathed heater; wherein a gap is defined in the sheathed heater retaining portion where the sheathed heater is retained by the cylindrical body between the end on the sheathed heater side and the heating element constituted by heating wire inside the sheathed heater.

Here, the end on the sheathed heater side in the sheathed heater retaining portion formed with the cylindrical body may be structured with the bottom of the concave portion provided to the cylindrical body.

According to the foregoing constitution, as a result of providing a gap between the retaining portion end on the body side and the heating element formed with the likes of heating wire on the sheathed heater side in the sheathed heater retaining portion formed with the cylindrical body, heat will not be transmitted easily from the sheathed heater side to the body side, and heat transmission to the engine cooling water can be conducted efficiently so as to exhibit the antifreeze function thereof. Therefore, there is no need to take measures such as increasing the heater capacity more than necessary, and problems such as the copper pipe structuring the sheath melting due to heat transmission can be eliminated.

Moreover, the block heater according to the present invention (invention according to claim 5) comprises a sheathed heater having a heating element embedded in heat-resistant insulation powder inside a heat-resistant metal sheath; a cylindrical body for retaining the back-end portion of the sheathed heater and mounted onto a heater mounting portion at an area in contact with the cooling water inside an automotive engine water jacket; and a cap attached to the opposite end of the sheathed heater of the cylindrical body, and structured so as to retain an end of a cable connected to the sheathed heater, the cable having a power supply outlet at the other end thereof, and the connection end being constructed connectably to the sheathed heater; wherein the a part on one end side in the axial direction of the sheathed heater retaining portion where the sheathed heater is retained by said cylindrical body is caulked in the entire circumference thereof so as to fix the part, and a part on the other end side in the axial direction of said retaining portion is soldered in the entire circumference thereof so as to fix the part.

According to the foregoing constitution, one end side in the longitudinal direction in the retaining portion will be caulked in the entire circumference thereof and the other end side will be soldered in the entire circumference thereof for fixation in the retaining portion where the sheathed heater is fitted into the cylindrical body, and, in addition to being able to secure the reliable fixed state thereof, reliable sealability can also be obtained in such retaining portion.

Further, the block heater according to the present invention (invention according to claim 6) comprises a sheathed heater having a heating element embedded in heat-resistant insulation powder inside a heat-resistant metal sheath; a cylindrical body for retaining the back-end portion of the sheathed heater and mounted onto a heater mounting portion of an automotive engine block; and a cap attached to the opposite end of the sheathed heater of the cylindrical body, and structured so as to retain an end of a cable connected with a sheathed heater, the cable having a power supply outlet at the other end thereof, and the connection being constructed connectably to the sheathed heater; wherein, when the cooling water inside the engine water jacket becomes empty or when the amount of cooling water falls below a prescribed amount, the nichrome wire inside the sheathed heater is disconnected so as to prevent the sheathed heater from generating heat.

According to the foregoing constitution, needless high temperatures can be avoided, and there is no fear of the cap melting and igniting, and resulting in the automobile catching fire.

### BRIEF DESCRIPTION OF THE DRAWINGS

FIG. 1 is an enlarged cross section of the relevant part showing an embodiment of the block heater according to the present invention;

FIG. 2 is a schematic cross section showing the entire block heater according to the present invention;

FIG. 3 shows the cylindrical body in the block heater according to the present invention; wherein FIG. 3(a) is an end view, and FIG. 3(b) is a cross section along line III-III thereof;

FIG. 4 shows the cap in the block heater according to the present invention; wherein FIG. 3(a) is an end view thereof, and FIG. 3(b) is a cross section along line IV-IV thereof; and

FIG. 5 is a schematic view for explaining the state of mounting the block heater according to the present invention onto an automotive engine block.

### DESCRIPTION OF THE PREFERRED EMBODIMENTS

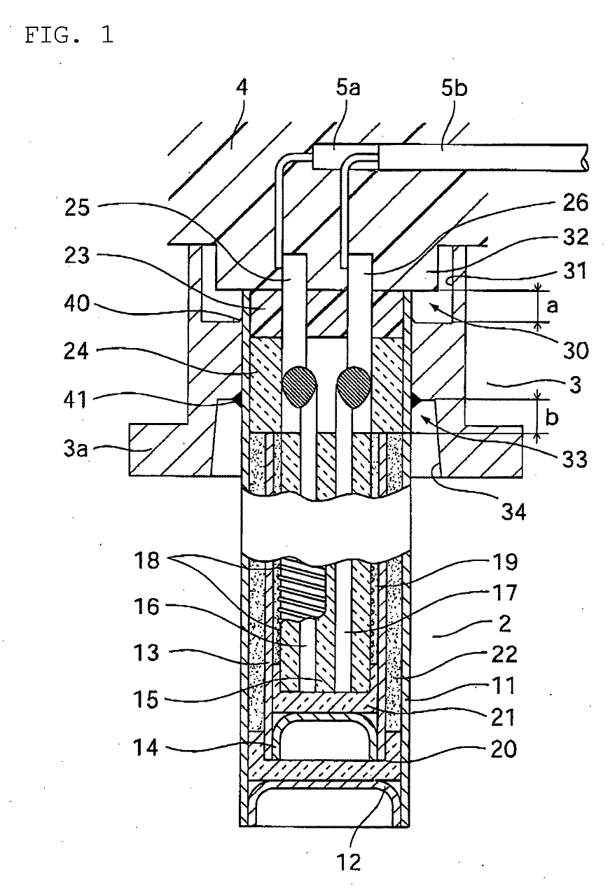

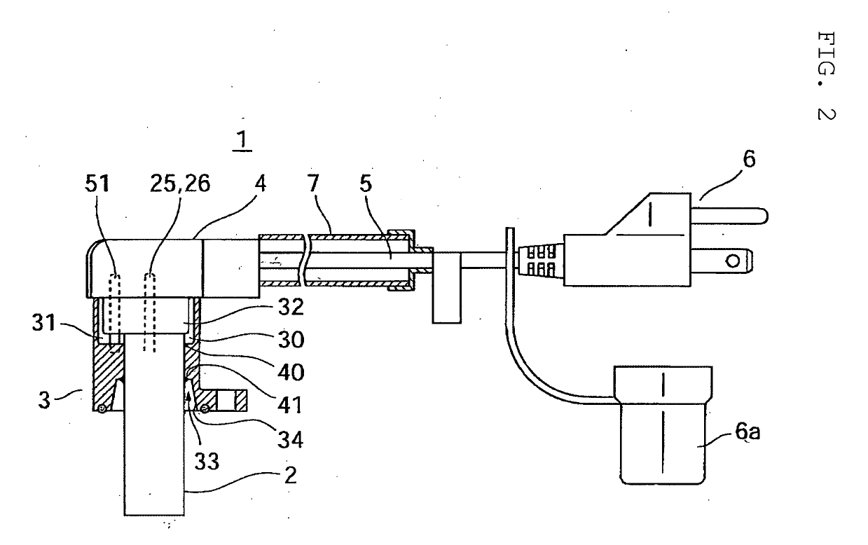

FIGS. 1 to 5 show an embodiment of the block heater according to the present invention.

In these drawings, as shown in FIGS. 1, 2, 5 and the like, the block heater 1 comprises a sheathed heater 2 as the heating element, a cylindrical body 3 for retaining the back-end portion of this sheathed heater 2, a cap 4 attached to the other end side of this cylindrical body 3, and a cable 5 for retaining the connection end for connection with the sheathed heater 2 inside this cap 4.

Provided to the other end of the cable 5 is a power source outlet 6 for connection with a household power supply in the likes of a parking lot upon using the block heater 2; that is, when the automobile is not being used at night or other times during winter, and this is sequentially assembled in a state including the power supply harness. Incidentally, when this outlet 6 is not inserted into the household power source; for instance, when thermal insulation is not required such as during the use of the automobile or during summer, such outlet 6 may be covered with a plug cap 6a.

Further, the cable 5 pulled out from the cap 4 is mostly covered with a protective pipe 7 up to the power source outlet 6.

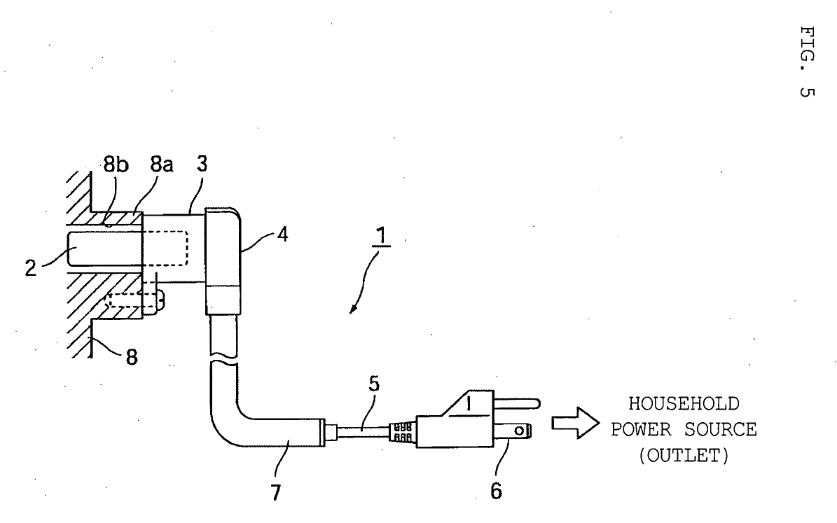

As shown in FIG. 5, this type of block heater 1 is screwed and fixed, via a flange 3a of the cylindrical body 3, to the heater mounting portion 8a provided to a location capable of keeping the engine cooling water warm in an area, in the engine block 8 for instance, in contact with the cooling water inside the automotive engine water jacket, and mounted so as to keep the engine cooling water warm with the tip of the sheathed heater 2 facing inside the mounting hole 8b.

In other words, this type of block heater 1 is fixed to the heater mounting unit 8a in a state where the sheathed heater 2 is facing inside the engine block 8. This is used by plugging in and maintaining the connection of the power source outlet 6 and the household power supply (outlet), for example, upon returning home and parking the automobile in the parking lot. Here, the sheathed heater 2 will generate heat upon being energized, and this generation of heat will keep the engine cooling water warm. When using the automobile, after starting up the engine, the outlet is removed and covered with the plug cap 6a, and the cable 5 is bundled and stored in a suitable location inside the engine room. During summer or when a certain degree of temperature can be ensured, the block heater 1 will be left stored.

Here, to explain the structure of the sheathed heater 2 with reference to FIG. 1, this sheathed heater 2 comprises an external sheath 11 formed with the likes of a copper tube, and the tip (bottom end) thereof is blocked with a cover 12. Further, inside this external sheath 11, an internal sheath 13 formed with the likes of a stainless steel tube is provided internally, and the tip (bottom end) thereof is blocked with a cover 14. Incidentally, the sheathes 11, 13 and covers 12, 14 are respectively assembled in advance with soldering or the like.

Reference numeral 15 is a columnar core formed with the likes of ceramic provided inside the internal sheath 13, and two penetration holes are formed in this core 15 along the axis line direction such that rod-shaped conductors 16, 17 may be penetrated and provided therethrough. Further, heating wire 18 formed from a material having heat-resistant strength such as nichrome is wound around and provided to the outer periphery of this core 15, wherein the heating element is formed with one end thereof being connected to one conductor 16, and the other end being connected to the other conductor 17. Incidentally, reference numeral 19 in FIG. 1 is heat-resistant insulation powder of magnesium oxide (MgO) or the like for embedding the core 15, heating wire 18 and so on inside the internal sheath 13.

In FIG. 1, reference numeral 20 is a spacer formed from the likes of ceramic and for prescribing the tip position of the internal sheath 13 inside the external sheath 11, and reference numeral 21 is a spacer formed from the likes of ceramic and for prescribing the tip position of the core 15 inside the internal sheath 13.

Moreover, reference numeral 22 is heat-resistant insulation powder of magnesium oxide (MgO) or the like for embedding the internal sheath 13 inside the external sheath 11.

When employing magnesium oxide as the heat-resistant insulation powder, upon reaching a certain temperature, a part of the magnesium oxide is reduced and becomes magnesium, and as a result becomes a conductive material. As a result of the magnesium which became a conductive material connecting the pitches of the heating wire 18 wound in a coil shape and causing electricity to flow, resistance of the entire heating wire will decrease and current beyond the allowable current will flow, thereby disconnecting the heating wire 18. As a result, electricity will not flow to the heating wire 18, and heat will not be generated.

With the foregoing constitution, for example, when the amount of cooling water inside the engine water jacket decreases more than necessary due to evaporation or leaks and becomes nearly empty, the sheathed heater will no longer be immersed in the cooling water. Thus, the heat generated from the heating wire 18 will no longer be lost to the cooling water and will escape to the cylindrical body 3 or cap 4, and it is therefore possible to prevent the cap 4 from melting and spontaneously combusting and causing the automobile to catch fire.

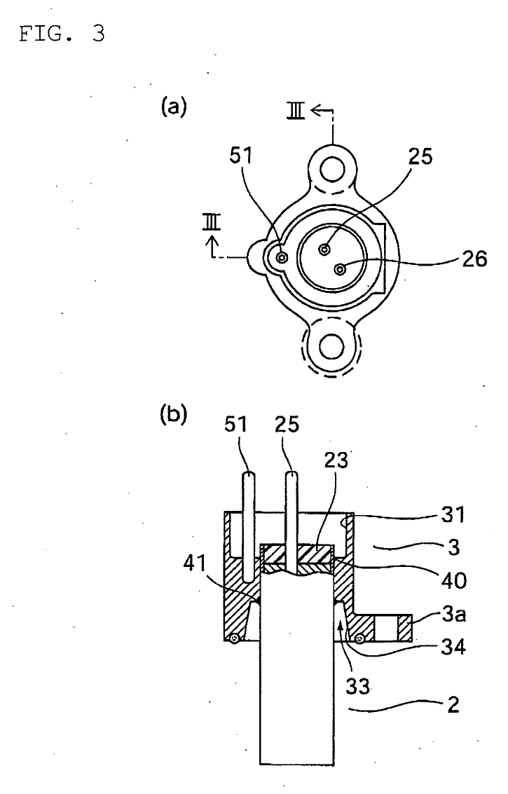

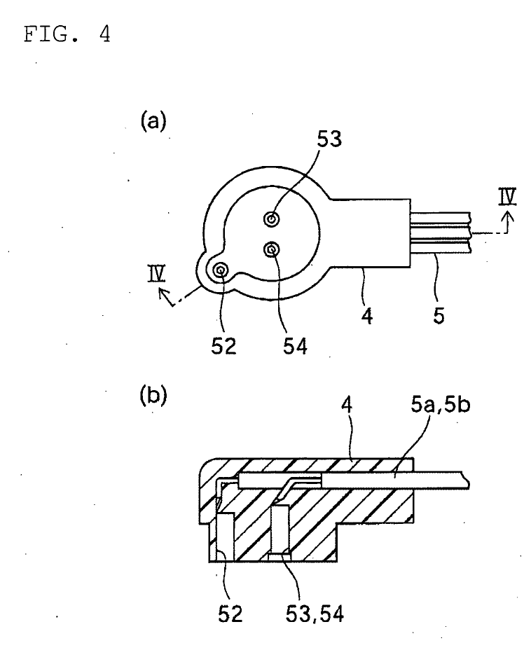

Further, reference numeral 23 is a sealing member such as silicon rubber for hermetically sealing the base end (upper end) of the external sheath 11, and reference numeral 24 is a spacer formed with the likes of ceramic interposed between the sealing member 23 and the internal sheath 13. Moreover, reference numerals 25, 26 are contact terminals connected to rod-shaped conductors 16, 17 via soldering or the like, and are extendedly provided from the back-end portion of the sheathed heater 2 in the axis line direction. As evident from FIGS. 3 and 4, these contact terminals 25, 26 are fitted into the contact holes 53, 54 provided openly to the end face of the cap 4, and connected to the conductors 5a, 5b structuring the cable 5 inside these contact holes.

Further, in FIG. 3, reference numeral 51 is a contact terminal for earth connection provided to the body 3 side, and, in correspondence thereto, a contact hole 52 is provided to the cap 4 as shown in FIG. 4, and an earth connection is realized thereby.

Moreover, in the sheathed heater 2 having the foregoing constitution, swaging processing is performed to both the internal sheath 13 and external sheath 11 in a state where the respective internal assembly components have been built in, and assembly can thereby conducted in a desired state. As the details are well known, the explanation there of will be omitted.

According to the present invention, in the cylindrical body 3 provided so as to retain the back-end portion of the sheathed heater 2 having the foregoing structure, a gap 30 is defined at the assembly portion with the cap 4 for retaining the connection end of the cable 5 (5a, 5b), the gap 30 being in such a size that the thermal effect on the body 3 side does not affect the cap 4 side.

Here, in this embodiment, as shown in FIG. 1, a gap 30 of size a is formed between the bottom of the cap assembly opening 31 of the body 3 and the joint end face 32 on the cap 4 side. This size a may be several millimeters to several ten millimeters, but is not limited thereto.

Further, in the present embodiment, although the sidewall forming the opening 31 of the body 3 and the peripheral face of the joint of the cap 4 are in an approximate contacting state, the heat transmission is maintained at a minimum while enabling dust control.

According to the above, since the cylindrical body for retaining the back-end portion of the sheathed heater to become the heating element and the cap for retaining the cable connection end may be connected via a prescribed gap, heat transmission from the body 3 side to the cap 4 may be kept to a minimum, and, even if the cooling water inside the engine water jacket decreases and causes a low-water condition, the cap 4 will not melt.

Moreover, according to the present invention, a gap is defined between the retaining portion end on the body 3 side and the heating element constituted by the likes of heating wire 18 on the sheathed heater 2 side in the retaining portion where the sheathed heater 2 is retained by the cylindrical body 3.

Here, in the present embodiment, a gap 33 of size b is provided between the base end of the internal sheath 13 of the sheathed heater 2 and the heater retaining portion end of the body 3. This size b may be several millimeters to several ten millimeters, but is not limited thereto. Moreover, a gap of several centimeters may be provided between the base end side of the heating wire 18 inside the sheathed heater 2 and the heater retaining portion end of the body 3.

According to the above, heat will not be transmitted easily from the sheathed heater 2 side to be the heating element to the body 3 side, and heat transmission to the engine cooling water can be conducted efficiently so as to exhibit the antifreeze function thereof. Therefore, there is no need to take measures such as increasing the heater capacity more than necessary, and problems such as the copper pipe structuring the sheath melting due to heat transmission can be eliminated.

Here, in FIG. 1, reference numeral 34 is a concave portion for providing a gap between the outer periphery of the sheathed heater 2 in the body 3 end. Although heat from the sheathed heater 2 side will remain in this concave portion 34, this will enable the prevention of excessive heat from escaping to the body 3 side.

Further, according to the present invention, in the part where the external sheath 11 constituting the sheathed heater 2 is held by being inserted into the cylindrical body 3, as shown in FIG. 1, one end side (portion illustrated with reference numeral 40 at the upper end side in FIG. 1) in the longitudinal direction in the retaining portion will be caulked in the entire circumference thereof and the other end side (portion illustrated with reference numeral 41 at the lower end side in FIG. 1) will be soldered in the entire circumference thereof for fixation in the retaining portion where the sheathed heater is fitted into the cylindrical body.

According to the above, the sheathed body 2 can be attached to the body 3 via caulking so as to secure the reliable fixed state thereof, and reliable sealability can also be obtained in such retaining portion.

In addition, the present invention is not limited to the constitution explained in the foregoing embodiments, and, needless to say, the shape, structure, material and so on of the respective components structuring the block heater may be suitably modified or changed. Further, the position of mounting the block heater is not limited to the engine block, and any location will suffice so as long as the position is in contact with the cooling water inside the water jacket.

For instance, in the foregoing embodiments, although a case of employing a double wound structure as the sheathed heater was exemplified, the present invention is not limited thereto, and a sheathed heater having a single tube structure or any other well-known structure may be employed to exhibit the effects described above as a matter of course.

According to the block heater of the present invention as described above, since the cylindrical body for retaining the back-end portion of the sheathed heater to become the heating element and the cap for retaining the cable connection end will be connected via a prescribed gap, heat transmission from the body side to the cap can be held to a minimum, and the cap will therefore not melt.

Further, according to the present invention, as a result of providing a gap between the retaining portion end on the body side and the heating element formed with the likes of heating wire on the sheathed heater side in the sheathed heater retaining portion formed with the cylindrical body, heat will not be transmitted easily from the sheathed heater side to the body side, and heat transmission to the engine cooling water can be conducted efficiently so as to exhibit the antifreeze function thereof. Still further, as a result of employing a structure in which nichrome wire or the like in the sheathed heater is disconnected when temperature exceeds a certain level, the temperature will never reach such a level that the entire block heater is fired, and hence it is possible to obtain effective vehicle fire prevention function. Therefore, there is no need to take measures such as increasing the heater capacity more than necessary, and such a problem that the copper pipe structuring the sheath or the cap melts due to heat transmission can be eliminated.

Moreover, according to the present invention, one end side in the longitudinal direction in the retaining portion will be caulked in the entire circumference thereof and the other end side will be soldered in the entire circumference thereof for fixation in the retaining portion where the sheathed heater is fitted into the cylindrical body, and, in addition to being able to secure the reliable fixed state thereof, a superior effect is yielded in that reliable sealability can also be obtained in such retaining portion.

What is claimed is:

1. A block heater, comprising:
a sheathed heater having a heating element embedded in heat-resistant insulation powder inside a heat-resistant metal sheath;
a cylindrical body for retaining the back-end portion of said sheathed heater and mounted onto a heater mounting portion at an area in contact with cooling water inside an automotive engine water jacket; and
a cap attached to the opposite end of said sheathed heater of said cylindrical body, and structured so as to retain an end of a cable connected to the sheathed heater, the cable having a power supply outlet at the other end thereof, and said connection end being constructed connectably to said sheathed heater;
wherein a gap is defined between the end on the cap side of said cylindrical body and the end on the body side of said cap.

2. A block heater according to claim 1, wherein said gap is formed between the end portions of said cylindrical body and cap so as to define clearance of a prescribed measurement in the axial direction.

3. A block heater, comprising:
a sheathed heater having a heating element embedded in heat-resistant insulation powder inside a heat-resistant metal sheath;
a cylindrical body for retaining the back-end portion of said sheathed heater and mounted onto a heater mounting portion at an area in contact with cooling water inside an automotive engine water jacket; and
a cap attached to the opposite end of said sheathed heater of said cylindrical body, and structured so as to retain an end of a cable connected with a sheathed heater, the cable having a power supply outlet at the other end thereof, and said connection end being constructed connectably to said sheathed heater;
wherein a gap is defined in the sheathed heater retaining portion where the sheathed heater is retained by said cylindrical body between the end on said sheathed heater side and the heating element constituted by heating wire inside said sheathed heater.

4. A block heater according to claim 3, wherein the end on said sheathed heater side in the sheathed heater retaining portion where the sheathed heater is retained by said cylindrical body is structured with the bottom of a concave portion provided to said cylindrical body.

5. A block heater, comprising:
a sheathed heater having a heating element embedded in heat-resistant insulation powder inside a heat-resistant metal sheath;
a cylindrical body for retaining the back-end portion of said sheathed heater and mounted onto a heater mounting portion at an area in contact with cooling water inside an automotive engine water jacket; and
a cap attached to the opposite end of said sheathed heater of said cylindrical body, and structured so as to retain an end of a cable connected with a sheathed heater, the cable having a power supply outlet at the other end thereof, and said connection end being constructed connectably to said sheathed heater;
wherein a part on one end side in the axial direction of the sheathed heater retaining portion where the sheathed heater is retained by said cylindrical body is caulked in the entire circumference thereof so as to fix the part, and a part on the other end side in the axial direction of said retaining portion is soldered in the entire circumference thereof so as to fix the part.

6. A block heater, comprising:
a sheathed heater having a heating element embedded in heat-resistant insulation powder inside a heat-resistant metal sheath;
a cylindrical body for retaining the back-end portion of said sheathed heater and mounted onto a heater mounting portion of an automotive engine block; and
a cap attached to the opposite end of said sheathed heater of said cylindrical body, and structured so as to retain an end of a cable to be connected with a sheathed heater, the cable having a power supply outlet at the other end thereof, and said connection end being constructed connectably to said sheathed heater;
wherein, when the cooling water inside the engine water jacket runs out or when the amount of cooling water falls below a prescribed amount, nichrome wire inside the sheathed heater is disconnected so as to prevent the sheathed heater from generating heat.
